(19) United States
(12) Patent Application Publication
(10) Pub. No.: US 2012/0159764 A1
(43) Pub. Date: Jun. 28, 2012

(54) HEADER OBSERVATION MIRROR ON COMBINE CAB

(75) Inventor: Bernard D. Reiger, Newton, KS (US)

(73) Assignee: AGCO CORPORATION, Duluth, GA (US)

(21) Appl. No.: 13/329,513

(22) Filed: Dec. 19, 2011

Related U.S. Application Data
(60) Provisional application No. 61/426,748, filed on Dec. 23, 2010.

(51) Int. Cl. B23P 11/00

(52) U.S. Cl. 29/428

(57) ABSTRACT

Disclosed is a method of mating a feederhouse of a combine vehicle with a harvesting header using an observation mirror mounted near an operator's cab of the combine vehicle. The mirror is oriented such that a reflection of a forward part of a feeder house is visible to an operator of the combine vehicle is visible to the operator while in the operator's cab. The combine vehicle is then driven towards the harvesting header while the operator observes the relative position of the feederhouse and a pick-up header on the harvesting header to guide the combine vehicle into position to mate with the harvesting header.

### CROSS REFERENCE TO RELATED APPLICATIONS

This application claims priority to U.S. Provisional Application No. 61/426,748 filed Dec. 23, 2010, entitled “HEADER OBSERVATION MIRROR ON COMBINE CAB”.

### BACKGROUND OF THE INVENTION

1. Field of Invention

This invention relates generally to harvesting headers for combines, and more particularly to the use of an observation mirror to guide the operator of a combine when mounting the header.

2. Description of Related Art

As is known in the art, harvesting combines typically have a self propelled combine vehicle and a harvesting header. Often, before the combine can be driven on public roads, the harvesting header needs to be removed and placed on a towed vehicle in order to reduce the transport width and reduce the load on the front axle of the combine to permissible values. When the combine reaches the field, the harvesting header must then be coupled to the combine.

Coupling a combine and a harvesting header together is in many cases a difficult task. Generally, the combine has a feeder house with detents at its tip and the harvesting header has a header pickup with grooves configured to receive the detents on the feeder house. Thus, the combine needs to be driven forwards in a manner such that the feeder house correctly hits the header pick-up. The task of coupling a combine and the harvesting header together is difficult especially in agricultural harvesting conditions with uneven terrain. Thus, there is a need for an improved method of coupling a combine and harvesting header.

### SUMMARY OF THE INVENTION

In one aspect, the invention relates to a method of mating a feederhouse of a combine vehicle with a harvesting header. The method includes mounting an observation mirror near an operator's cab of the combine vehicle. The mirror is oriented such that a reflection of a forward part of a feeder house is visible to an operator of the combine vehicle while in the operator's cab. The combine vehicle is then driven towards the harvesting header while the operator observes the relative position of the feederhouse and a pick-up header on the harvesting header to guide the combine vehicle into position to mate with the harvesting header.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of a combine and header according to an embodiment of the invention;

FIG. 2 is an enlarged view of portions of the combine of FIG. 1 illustrating a header observation mirror for use in mounting the header; and

FIG. 3 is a view of the header observation mirror of FIG. 2.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

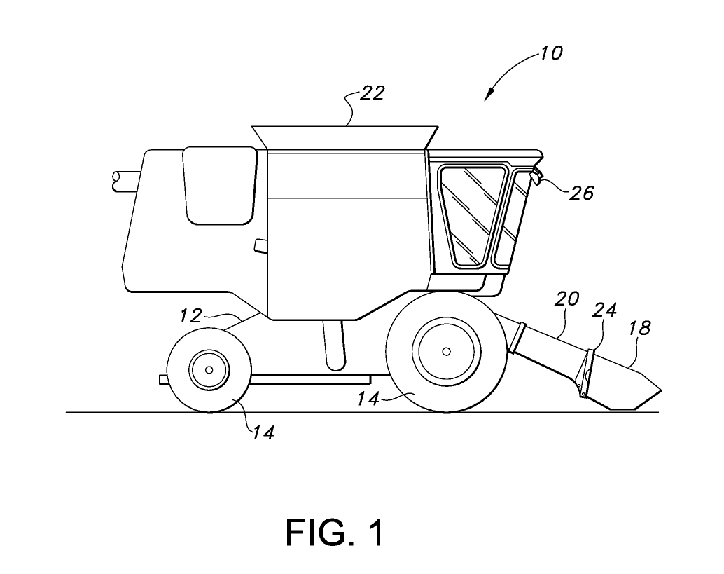

FIG. 1 shows a combine vehicle 10 having a chassis 12. A propulsion unit 14, which may include tires and/or tracks that engage the ground, is coupled to chassis 12, and performs propulsion and steering functions. The operation of combine is controlled from an operator's cab 16. In operation, a harvesting header 18 is used for harvesting a crop and directing the crop to a feederhouse 20. The harvested crop is directed during harvesting operation by the feederhouse 20 to a crop processing unit 22 having an infeed section, a threshing section and a separating section as is known in the art. The harvesting header mounts on the feederhouse with a header pick-up 24.

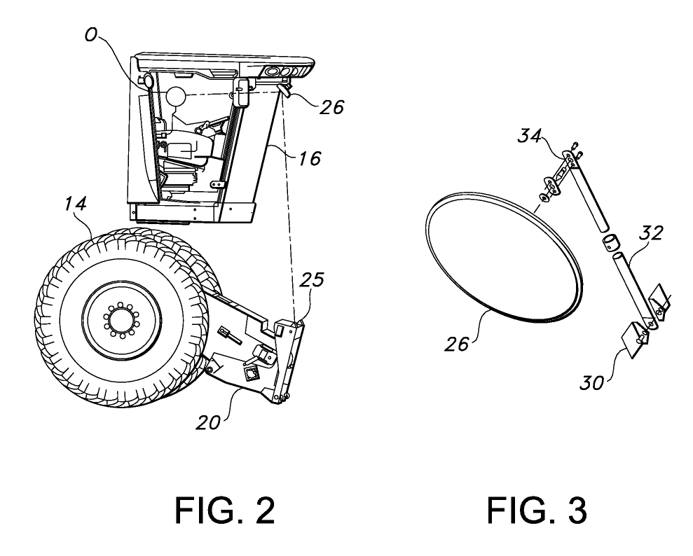

As best seen in FIG. 2, the feederhouse 20 has detents 25 at its forward end configured to engage the header pickup (FIG. 1). When mounting the harvesting header 18, the combine vehicle 10 needs to be driven forwards in a manner such that the feederhouse 20 correctly hits the header pick-up 24 on the harvesting header 18. According to the invention, an observation mirror 26 is mounted forward of the operator's cab 16 to aid the operator in observing the mating of the feederhouse 20 with the header pick-up 24. The observation mirror 26 can be a conventional planer or a convex mirror having a standard or wide angle view. As can be seen in the view of FIG. 2, the observation mirror 26 is positioned near the forward portion of the operator's cab 16 such that an operator O can see the observation mirror 26 while looking in the forward direction but is positioned behind the detents 25 on the feederhouse 20. The observation mirror 26 is angled or oriented such that the reflection of the forward portion of the feederhouse 20 with the detents 25 is visible to the operator O in the observation mirror 26. As seen in FIG. 3, in one embodiment, the observation mirror 26 is mounted with a mounting bracket 30 that attaches to the combine vehicle 10 near the operator's cab 16 and an arm 32 that is pivotable with respect to the mounting bracket 30. The observation mirror 26 may also have a mirror bracket 34 that mounts the observation mirror 26 onto the arm 32 such that the observation mirror 26 also may pivot with respect to the arm 32.

Accordingly, when it is desired to mount the harvesting header on the feederhouse 20 of the combine vehicle 10, the observation mirror 26 is adjusted or oriented such that the reflection of the forward tip of the feederhouse 20 and the detents thereon is visible to the operator O in the observation mirror 26. The operator O then drives the combine vehicle 10 forward until the feederhouse meets the header pick-up 24.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. A method of mating a harvesting header with a feederhouse of a combine vehicle, the method comprising:
mounting an observation mirror near an operator's cab of the combine vehicle;
orienting the mirror such that a reflection of a forward part of a feeder house is visible to an operator of the combine vehicle in the operator's cab; and
moving the combine vehicle toward the harvesting header while the operator observes the relative position of the feederhouse and a pick-up header on the harvesting header to guide the combine vehicle into position to mate with the harvesting header.
